(19) United States
(12) Patent Application Publication
(10) Pub. No.: US 2026/0180127 A1
(43) Pub. Date: Jun. 25, 2026

(54) LEAD ACID STORAGE BATTERY AND METHOD FOR PRODUCING SAME

(71) Applicant: Energywith Co., Ltd., Tokyo (JP)

(72) Inventors: Ryoji OHTSUBO, Tokyo (JP); Hiroki HIRANO, Tokyo (JP)

(21) Appl. No.: 18/856,330

(22) PCT Filed: Apr. 3, 2023
(86) PCT No.: PCT/JP2023/013835

§ 371 Date: Oct. 11, 2024

(30) Foreign Application Priority Data
Apr. 15, 2022 (JP) 2022-067642

(51) Int. Cl. H01M 50/449; H01M 10/06; H01M 50/437; H01M 50/44

(52) U.S. Cl. CPC H01M 50/449; H01M 10/06; H01M 50/437; H01M 50/44

(57) ABSTRACT

A lead acid storage battery 100 having a positive electrode 20, a negative electrode 30, a separator 40, and a porous membrane 50, in which the separator 40 and the porous membrane 50 contain a glass fiber and are disposed between the positive electrode 20 and the negative electrode 30, the porous membrane 50 is disposed in at least one of a position between the positive electrode 20 and the separator 40 and a position between the negative electrode 30 and the separator 40, and a void ratio of the porous membrane 50 as obtained by X-ray CT measurement is 18.0% or more.

### TECHNICAL FIELD

The present disclosure relates to a lead acid storage battery, a method for producing a lead acid storage battery, and the like.

### BACKGROUND ART

Lead acid storage batteries are one of secondary batteries that have been conventionally used, and are widely used as secondary batteries for an industry or consumer use because of its reliability, low price, and the like. For example, lead acid storage batteries can be used as lead acid storage batteries for automobiles, lead acid storage batteries for electric vehicles, lead acid storage batteries for power-supply devices.

There is a case where an increase in output is required for lead acid storage batteries, and it has been studied, for example, that the number of electrodes in a battery container is increased by reducing a thickness of a separator disposed between a positive electrode and a negative electrode. However, when the thickness of the separator is reduced, there is a case where lead sulfate is easily dissolved in the separator in a chemical formation treatment of the battery manufacturing process, and permeation short-circuiting occurs due to charging and discharging. In response to this, a technique of solving permeation short-circuiting and the like by improving the separator has been known (see, for example, Patent Literatures 1 and 2 below).

### CITATION LIST

### Patent Literature

Patent Literature 1: Japanese Unexamined Patent Publication No. H11-260335
Patent Literature 2: Japanese Unexamined Patent Publication No. 2002-151033

### SUMMARY OF INVENTION

### Technical Problem

From the viewpoint of adopting the wide variety of configurations in a lead acid storage battery, a new technique is demanded as a technique of solving permeation short-circuiting.

An object of an aspect of the present disclosure is to provide a lead acid storage battery capable of suppressing permeation short-circuiting at the time of a chemical formation treatment. An object of another aspect of the present disclosure is to provide a method for producing a lead acid storage battery for obtaining such a lead acid storage battery.

### Solution to Problem

The present inventors have conceived that, as a member disposed between the positive electrode and the negative electrode, a porous membrane is used in addition to the separator, but have found that there is a case where permeation short-circuiting at the time of a chemical formation treatment is not suppressed even in the case of using a porous membrane having a high porosity ratio from the viewpoint of increasing the diffusibility of the electrolytic solution and favorably promoting a battery reaction. In response to this, the present inventors have found that selecting a porous membrane on the basis of a void ratio of a porous membrane as obtained by X-ray CT measurement is effective in suppressing permeation short-circuiting.

The present disclosure relates to the following [1] to [6] and the like in some aspects.

[1] A lead acid storage battery having a positive electrode, a negative electrode, a separator, and a porous membrane, in which the separator and the porous membrane contain a glass fiber and are disposed between the positive electrode and the negative electrode, the porous membrane is disposed in at least one of a position between the positive electrode and the separator and a position between the negative electrode and the separator, and a void ratio of the porous membrane as obtained by X-ray CT measurement is 18.0% or more.
[2] The lead acid storage battery described in [1], in which the porous membrane includes a porous membrane disposed between the negative electrode and the separator.
[3] The lead acid storage battery described in [1] or [2], in which the porous membrane is a nonwoven fabric.
[4] The lead acid storage battery described in any one of [1] to [3], in which a thickness of the porous membrane is smaller than a thickness of the separator.
[5] The lead acid storage battery described in any one of [1] to [4], in which a thickness of the porous membrane is 0.01 to 0.50 mm.
[6] A method for producing the lead acid storage battery described in any one of [1] to [5], the method including disposing the porous membrane between the positive electrode and the negative electrode.

### Advantageous Effects of Invention

According to an aspect of the present disclosure, it is possible to provide a lead acid storage battery capable of suppressing permeation short-circuiting at the time of a chemical formation treatment. According to another aspect of the present disclosure, it is possible to provide a method for producing a lead acid storage battery for obtaining such a lead acid storage battery.

### BRIEF DESCRIPTION OF DRAWINGS

FIG. 1 is an end view illustrating an example of a lead acid storage battery.

### DESCRIPTION OF EMBODIMENTS

Hereinafter, embodiments of the present disclosure will be described, but the present disclosure is not limited to these embodiments at all.

In the present specification, a numerical range that has been indicated by use of “to” indicates the range that includes the numerical values which are described before and after “to”, as the minimum value and the maximum value, respectively. In a numerical range described stepwise in the present specification, an upper limit value or a lower limit value of a numerical range of a certain stage can be arbitrarily combined with an upper limit value or a lower limit value of a numerical range of another stage. In a numerical range described in the present specification, an upper limit value or a lower limit value of the numerical range may be replaced with a value shown in Examples. “A or B” may include either one of A and B, and may also include both of A and B. Materials listed as examples in the present specification can be used singly or in combinations of two or more kinds, unless otherwise specified. When a plurality of substances corresponding to each component exist in a composition, the content of each component in the composition means the total amount of the plurality of substances that exist in the composition, unless otherwise specified. The term “film” is meant to include a structure having a shape which is formed over the entire surface when observed in a plan view, as well as a structure having a shape which is formed in a portion. The term “step” includes not only an independent step but also a step by which an intended action of the step is achieved, even though the step cannot be clearly distinguished from other steps. The specific gravity varies depending on a temperature, and accordingly is defined as a specific gravity which is converted to that at 25° C. in the present specification. The term “(meth)acryl” means at least one of acryl and methacryl corresponding thereto.

A lead acid storage battery of the present embodiment has a positive electrode, a negative electrode, a separator, and a porous membrane, in which the separator and the porous membrane contain a glass fiber and are disposed between the positive electrode and the negative electrode, and the porous membrane is disposed in at least one of a position between the positive electrode and the separator (a position between the positive electrode and the separator) and a position between the negative electrode and the separator (a position between the negative electrode and the separator). In the lead acid storage battery of the present embodiment, a void ratio of the porous membrane as obtained by X-ray CT measurement is 18.0% or more.

According to the lead acid storage battery of the present embodiment, it is possible to suppress permeation short-circuiting at the time of a chemical formation treatment. According to the lead acid storage battery of the present embodiment, permeation short-circuiting can be suppressed while achieving high output by reducing the thickness of the separator.

In the lead acid storage battery of the present embodiment, by disposing the porous membrane, an excessive increase in content of lead ions in the separator is suppressed. On the other hand, when the void ratio of the porous membrane is low, the electrolytic solution is difficult to sufficiently diffuse, which may cause unevenness in the specific gravity of the electrolytic solution inside the separator. In this case, lead sulfate may precipitate due to a difference in solubility of lead sulfate, resulting in permeation short-circuiting. On the other hand, in the lead acid storage battery of the present embodiment, since the void ratio is in the above-described range, the electrolytic solution is easy to sufficiently diffuse, and unevenness in the specific gravity of the electrolytic solution inside the separator is suppressed, so that permeation short-circuiting can be suppressed. However, the factors that suppress permeation short-circuiting are not limited to these contents.

The lead acid storage battery of the present embodiment can be used as a control valve type lead acid storage battery. The lead acid storage battery of the present embodiment can be used in automobiles, power-supply devices, and the like. Examples of the power-supply devices include a UPS (Uninterruptible Power Supply), a power supply for disaster prevention (emergency) radio, and a power supply of telephones. The automobile, electric vehicle, or the power-supply device of the present embodiment has the lead acid storage battery of the present embodiment.

The lead acid storage battery of the present embodiment has an electrode group of the present embodiment and a battery container accommodating the electrode group. The electrode group of the present embodiment is an electrode group for a lead acid storage battery, and has the positive electrode, the negative electrode, the separator, and the porous membrane described above. As the lead acid storage battery and the electrode group of the present embodiment, a lead acid storage battery and an electrode group before chemical formation can be used. The battery container is hollow and has an internal space accommodating the electrode group. The lead acid storage battery of the present embodiment may have a lid sealing the battery container. The lid may be provided with a control valve controlling a pressure in the battery container, a positive electrode terminal connecting the positive electrode to the outside, and a negative electrode terminal connecting the negative electrode to the outside.

It is sufficient that the lead acid storage battery and the electrode group have at least one positive electrode, and the lead acid storage battery and the electrode group may have a plurality of positive electrodes. It is sufficient that the lead acid storage battery and the electrode group have at least one negative electrode, and the lead acid storage battery and the electrode group may have a plurality of negative electrodes. The number of positive electrodes and the number of negative electrodes in the lead acid storage battery and the electrode group may be same, and may not be same. In a case where the number of positive electrodes and the number of negative electrodes are not same, the number of negative electrodes may be larger than the number of positive electrodes. The number of positive electrodes or negative electrodes may be 3 or more or 4 or more. The number of positive electrodes or negative electrodes may be 10 or less, 8 or less, 6 or less, 5 or less, 4 or less, or 3 or less. From these viewpoints, the number of positive electrodes or negative electrodes may be 3 to 10, 3 to 8, or 3 to 5. At least one (one or both) of the outermost electrodes in the electrode group may be a negative electrode.

The positive electrode has a positive electrode current collector and a positive electrode active material supported by the positive electrode current collector. The negative electrode has a negative electrode current collector and a negative electrode active material supported by the negative electrode current collector. The positive electrode and the negative electrode may be alternately disposed with the separator and the porous membrane interposed therebetween. A member of the positive electrode excluding the positive electrode current collector is referred to as “positive electrode active material”, and a member of the negative electrode excluding the negative electrode current collector is referred to as “negative electrode active material”.

The positive electrode current collector serves as an electrical conducting path for current from the positive electrode active material and retains the positive electrode active material. The negative electrode current collector serves as an electrical conducting path for current from the negative electrode active material and retains the negative electrode active material. The negative electrode current collector may be same as or different from the positive electrode current collector. Examples of the constituent material for the current collector include lead alloys such as a lead-calcium-tin-based alloy and a lead-antimony-arsenic-based alloy. Depending on use applications, selenium, silver, bismuth, or the like may be added to the current collector. The current collector has, for example, a grid shape and may be a casted grid body, an expanded grid body, or the like. The current collector can be obtained by forming a lead alloy in a grid shape by a gravity casting method, an expanding method, a punching method, or the like.

The plurality of positive electrodes may be electrically connected to each other by connecting edge portions provided in the positive electrode current collector via a strap. The strap of the positive electrode may be provided with a positive electrode post for connecting the positive electrode to the positive electrode terminal. The plurality of negative electrodes may be electrically connected to each other by connecting edge portions provided in the negative electrode current collector via a strap. The strap of the negative electrode may be provided with a negative electrode post for connecting the negative electrode to the negative electrode terminal.

The positive electrode active material can contain β-PbO₂ as a Pb component. The positive electrode active material may contain α-PbO₂, and may not contain α-PbO₂. The positive electrode active material can contain, as necessary, a Pb component (for example, PbSO₄) other than PbO₂, an additive, or the like.

Examples of the additive that can be contained in the positive electrode active material include a carbon material (excluding carbon fibers) and short fibers for reinforcement. Examples of the carbon material include carbon black and graphite. Examples of the carbon black include furnace black, channel black, acetylene black, thermal black, and ketjen black. Examples of the short fibers for reinforcement include acrylic fibers, polyethylene fibers, polypropylene fibers, polyethylene terephthalate fibers, and carbon fibers.

The negative electrode active material can contain Pb as a Pb component. The negative electrode active material may contain porous spongy lead. The negative electrode active material can contain, as necessary, a Pb component (for example, PbSO₄) other than Pb, an additive, or the like.

Examples of the additive that can be contained in the negative electrode active material include a resin having a sulfo group and/or a sulfonate group, barium sulfate, a carbon material (excluding carbon fibers), and short fibers for reinforcement. Examples of the resin having a sulfo group and/or a sulfonate group include lignin sulfonic acid, lignin sulfonate (for example, sodium ligninsulfonate), and a condensate of phenols, aminoarylsulfonic acid, and formaldehyde (for example, a condensate of bisphenol, aminobenzenesulfonic acid, and formaldehyde). The negative electrode active material may contain at least one selected from the group consisting of lignin sulfonic acid, lignin sulfonate, and a bisphenol-based resin from the viewpoint of easily obtaining excellent charge acceptance, and may contain a bisphenol-based resin from the viewpoint of easily obtaining particularly excellent charge acceptance. Examples of the carbon material include carbon black and graphite. Examples of the carbon black include furnace black, channel black, acetylene black, thermal black, and ketjen black. Examples of the short fibers for reinforcement include acrylic fibers, polyethylene fibers, polypropylene fibers, polyethylene terephthalate fibers, and carbon fibers.

The positive electrode active material and the negative electrode active material can be obtained by aging and drying an active material paste containing a raw material for an active material to obtain a chemically unformed active material and then chemically forming the chemically unformed active material. The positive electrode and the negative electrode can be obtained by aging and drying an active material paste supported on a current collector to obtain a chemically unformed active material and then chemically forming the chemically unformed active material. The active material paste may contain a solvent and/or sulfuric acid. Examples of the solvent include water (for example, ion-exchange water) and an organic solvent. A chemically unformed positive electrode active material may contain tribasic lead sulfate as a main component. Examples of the raw material for the positive electrode active material include a lead powder and red lead (Pb₃O₄). A chemically unformed negative electrode active material may contain tribasic lead sulfate as a main component. Examples of the raw material for the negative electrode active material include a lead powder.

The lead acid storage battery of the present embodiment has a separator disposed between the positive electrode and the negative electrode. As for the separator disposed between the positive electrode and the negative electrode, it is sufficient that at least a part of the separator is disposed between the positive electrode and the negative electrode.

The separator may be brought into contact with the positive electrode and may not be brought into contact with the positive electrode. The separator may cover at least a part of an active material region (a region where the positive electrode active material is disposed) of the positive electrode, and may cover the entire active material region of the positive electrode. The separator may be brought into contact with the negative electrode and may not be brought into contact with the negative electrode. The separator may cover at least a part of an active material region (a region where the negative electrode active material is disposed) of the negative electrode, and may cover the entire active material region of the negative electrode. The void ratio of the separator as obtained by X-ray CT measurement may be less than 18.0%. It is sufficient that the lead acid storage battery and the electrode group have at least one separator, and the lead acid storage battery and the electrode group may have a plurality of separators. The separator may be in a bag shape, and may be in a sheet shape (may not be in a bag shape). The separator may be folded back so as to cover the positive electrode or the negative electrode, and the folded-back portion may be located downward in the vertical direction in the lead acid storage battery.

In the separator, a rib may be disposed on at least one main surface selected from the group consisting of one surface and the other surface, and a rib may not be disposed on at least one main surface selected from the group consisting of one surface and the other surface. The separator can have at least one rib, and may have a plurality of ribs.

The separator contains a glass fiber. The separator may not contain an organic material (for example, an organic binder), and may contain an organic material. As a weight loss rate corresponding to a weight loss rate A described later, the weight loss rate (thermal weight loss rate) of the separator when the separator is heated at 800° C. for 15 minutes may be 5% or less, less than 5%, or 1% or less, based on the separator before being heated at 800° C.

Before being accommodated in the lead acid storage battery or after being accommodated in the lead acid storage battery, the thickness of the separator may be in the following range. The thickness of the separator may be 0.1 mm or more, 0.15 mm or more, 0.2 mm or more, more than 0.2 mm, 0.25 mm or more, 0.3 mm or more, more than 0.3 mm, 0.35 mm or more, or 0.4 mm or more, from the viewpoint of easily achieving high output. The thickness of the separator may be 5 mm or less, 4 mm or less, 3 mm or less, 2 mm or less, 1 mm or less, less than 1 mm, 0.9 mm or less, 0.8 mm or less, 0.7 mm or less, 0.65 mm or less, 0.6 mm or less, 0.55 mm or less, 0.5 mm or less, 0.45 mm or less, or 0.4 mm or less, from the viewpoint of easily suppressing permeation short-circuiting. From these viewpoints, the thickness of the separator may be 0.1 to 5 mm, 0.2 to 5 mm, more than 0.2 mm and 5 mm or less, 0.3 to 5 mm, more than 0.3 mm and 5 mm or less, 0.4 to 5 mm, 0.1 to 1 mm, 0.2 to 1 mm, more than 0.2 mm and 1 mm or less, 0.3 to 1 mm, more than 0.3 mm and 1 mm or less, or 0.4 to 1 mm. The thickness of the separator may be an average value (average thickness) of measured values at nine points in total (for example, one point in the center and eight equally spaced peripheral points).

The lead acid storage battery of the present embodiment has a porous membrane (a porous membrane for a lead acid storage battery) disposed between the positive electrode and the negative electrode. As for the porous membrane disposed between the positive electrode and the negative electrode, it is sufficient that at least a part of the porous membrane is disposed between the positive electrode and the negative electrode. Furthermore, the porous membrane is disposed in at least one of a position between the positive electrode and the separator and a position between the negative electrode and the separator. As for the porous membrane disposed between the positive electrode and the separator, it is sufficient that at least a part of the porous membrane is disposed between the positive electrode and the separator. As for the porous membrane disposed between the negative electrode and the separator, it is sufficient that at least a part of the porous membrane is disposed between the negative electrode and the separator.

The porous membrane may be brought into contact with the positive electrode and may not be brought into contact with the positive electrode. The porous membrane may cover at least a part of an active material region of the positive electrode, and may cover the entire active material region of the positive electrode. The porous membrane may be brought into contact with the negative electrode and may not be brought into contact with the negative electrode. The porous membrane may cover at least a part of an active material region of the negative electrode, and may cover the entire active material region of the negative electrode. The porous membrane of the lead acid storage battery of the present embodiment may include a porous membrane disposed between the negative electrode and the separator, and may not include a porous membrane disposed between the positive electrode and the separator, from the viewpoint of easily suppressing permeation short-circuiting. It is sufficient that the lead acid storage battery and the electrode group have at least one porous membrane, and the lead acid storage battery and the electrode group may have a plurality of porous membranes. The porous membrane may be in a bag shape, and may be in a sheet shape (may not be in a bag shape). The porous membrane may be folded back so as to cover the positive electrode or the negative electrode, and the folded-back portion may be located downward in the vertical direction in the lead acid storage battery.

The porous membrane contains a glass fiber, and may contain an organic material. Examples of the organic material include resin materials such as a (meth)acrylic resin (for example, a (meth)acrylic binder), an olefin-based resin, a urethane-based resin, and a styrene-based resin. Examples of the olefin-based resin include polyethylene and polypropylene. In the case of using a porous membrane containing a (meth)acrylic resin, the porous membrane adsorbs lead ions, an excessive increase in content of lead ions inside the separator is suppressed, and permeation short-circuiting is easily suppressed. The porous membrane may be a nonwoven fabric from the viewpoint of easily suppressing permeation short-circuiting.

Before being accommodated in the lead acid storage battery or after being accommodated in the lead acid storage battery, the thickness of the porous membrane may be in the following range. The thickness of the porous membrane may be 0.01 mm or more, 0.03 mm or more, 0.05 mm or more, 0.08 mm or more, 0.10 mm or more, 0.12 mm or more, 0.15 mm or more, 0.18 mm or more, 0.20 mm or more, 0.22 mm or more, 0.25 mm or more, 0.28 mm or more, or 0.30 mm or more, from the viewpoint of easily achieving high output. The thickness of the porous membrane may be 0.50 mm or less, 0.45 mm or less, 0.40 mm or less, less than 0.40 mm, 0.35 mm or less, 0.30 mm or less, less than 0.30 mm, 0.28 mm or less, 0.25 mm or less, 0.22 mm or less, 0.20 mm or less, less than 0.20 mm, 0.18 mm or less, 0.15 mm or less, 0.12 mm or less, or 0.1 mm or less, from the viewpoint of easily suppressing permeation short-circuiting. From these viewpoints, the thickness of the porous membrane may be 0.01 to 0.50 mm, 0.01 to 0.40 mm, 0.01 mm or more and less than 0.40 mm, 0.01 to 0.30 mm, 0.01 mm or more and less than 0.30 mm, 0.01 to 0.20 mm, 0.01 mm or more and less than 0.20 mm, 0.01 to 0.10 mm, 0.10 to 0.50 mm, 0.10 to 0.40 mm, 0.10 mm or more and less than 0.40 mm, 0.10 to 0.30 mm, 0.10 mm or more and less than 0.30 mm, 0.10 to 0.20 mm, 0.10 mm or more and less than 0.20 mm, 0.20 to 0.50 mm, 0.20 to 0.40 mm, 0.20 mm or more and less than 0.40 mm, or 0.20 to 0.30 mm. The thickness of the porous membrane may be an average value (average thickness) of measured values at nine points in total (for example, one point in the center and eight equally spaced peripheral points). The thickness of the porous membrane may be smaller than the thickness of the separator from the viewpoint of easily suppressing permeation short-circuiting.

Before being accommodated in the lead acid storage battery or after being accommodated in the lead acid storage battery, a ratio of the thickness of the porous membrane with respect to the thickness of the separator (the thickness of the porous membrane/the thickness of the separator) may be in the following range. The thickness ratio may be 0.1 or more, 0.15 or more, 0.2 or more, 0.25 or more, 0.3 or more, 0.35 or more, 0.4 or more, 0.45 or more, 0.5 or more, 0.55 or more, 0.6 or more, 0.65 or more, 0.7 or more, or 0.75 or more, from the viewpoint of easily suppressing permeation short-circuiting. The thickness ratio may be 1 or less, less than 1, 0.95 or less, 0.9 or less, 0.85 or less, 0.8 or less, 0.75 or less, 0.7 or less, 0.65 or less, 0.6 or less, 0.55 or less, 0.5 or less, 0.45 or less, 0.4 or less, 0.35 or less, 0.3 or less, or 0.25 or less, from the viewpoint of easily suppressing permeation short-circuiting. From these viewpoints, the thickness ratio may be 0.1 to 1, 0.1 or more and less than 1, 0.1 to 0.8, 0.1 to 0.75, 0.1 to 0.5, 0.1 to 0.3, 0.1 to 0.25, 0.2 to 1, 0.2 or more and less than 1, 0.2 to 0.8, 0.2 to 0.75, 0.2 to 0.5, 0.2 to 0.3, 0.2 to 0.25, 0.25 to 1, 0.25 or more and less than 1, 0.25 to 0.8, 0.25 to 0.75, 0.25 to 0.5, or 0.25 to 0.3.

The void ratio of the porous membrane obtained by X-ray CT measurement (3DCT measurement) is 18.0% or more from the viewpoint of suppressing permeation short-circuiting. That is, it is sufficient that the porous membrane includes at least a part of a region having such a void ratio, and the entire porous membrane may have such a void ratio.

The void ratio may be 19.0% or more, 20.0% or more, 21.0% or more, 22.0% or more, 23.0% or more, 24.0% or more, 25.0% or more, or 26.0% or more, from the viewpoint of easily suppressing permeation short-circuiting. The void ratio may be 50.0% or less, 45.0% or less, 40.0% or less, 35.0% or less, 30.0% or less, 29.0% or less, 28.0% or less, 27.0% or less, or 26.0% or less, from the viewpoint of easily suppressing permeation short-circuiting. From these viewpoints, the void ratio may be 18.0 to 50.0%, 20.0 to 50.0%, 23.0 to 50.0%, 25.0 to 50.0%, 18.0 to 30.0%, 20.0 to 30.0%, 23.0 to 30.0%, or 25.0 to 30.0%. The void ratio of the porous membrane can be adjusted by a method for producing a porous membrane (such as a wet method, a dry method, a spun-bonding method, a melt-blowing method, a thermal bonding method, a chemical bonding method, a needle-punching method, or a hydroentanglement method), the fiber diameter of the glass fiber used at the time of producing a porous membrane, and the like.

The void ratio of the porous membrane can be obtained by X-ray CT measurement (tube voltage: 55 kV, X-ray source: tungsten filament) of a measurement region adjusted to a cylindrical shape having a diameter of 10.178 mm and a height of 8.588 mm, and more specifically, the void ratio can be measured according to the following procedures.

(1) The porous membrane is irradiated with X rays (X-ray source: tungsten filament, using aluminum window) under the conditions of an X-ray tube voltage of 55 kV and brightness of 100 (max).
(2) Settings are performed as follows: “SID (Source Image Distance): 210 mm, SOD (Source Object Distance): 35 mm, detector inch size: 4 inches”, and X-ray CT measurement of a measurement region adjusted to a cylindrical shape having a diameter of 10.178 mm and a height of 8.588 mm is performed under the conditions of “measurement mode: full scan, number of views: 1200, number of integrations: 6 times×2 rotations, scaling factor: 100, image size: 512×512 pixels”.
(3) The measurement results of the X-ray CT measurement are 3D constructed to obtain a 3D image.
(4) The 3D image is rotated so that the main surface of the 3D image faces forward and the 3D image is converted into image data.
(5) Only the areas corresponding to the porous membrane (areas constituting the porous membrane) in the image data are extracted and then binarization is performed (binarization of areas corresponding to the porous membrane and areas not corresponding to the porous membrane (void parts) is performed).
(6) An area ratio of the black portions (areas not corresponding to the porous membrane) after binarization is obtained as a void ratio.

The porosity ratio of the porous membrane may be 50% by volume or more, 55% by volume or more, 60% by volume or more, 65% by volume or more, 70% by volume or more, 75% by volume or more, or 80% by volume or more, from the viewpoint of easily suppressing permeation short-circuiting. The porosity ratio of the porous membrane may be 95% by volume or less, 90% by volume or less, 85% by volume or less, or 80% by volume or less, from the viewpoint of easily suppressing permeation short-circuiting. From these viewpoints, the porosity ratio of the porous membrane may be 50 to 95% by volume, 70 to 90% by volume, 70 to 80% by volume, or 80 to 90% by volume. The porosity ratio of the porous membrane can be measured by mercury porosimetry. The porosity ratio of the porous membrane can be adjusted by a method for producing a porous membrane (such as a wet method, a dry method, a spun-bonding method, a melt-blowing method, a thermal bonding method, a chemical bonding method, a needle-punching method, or a hydroentanglement method), the fiber diameter of the glass fiber used at the time of producing a porous membrane, and the like. As the porosity ratio of the porous membrane after being brought into contact with the electrolytic solution (such as sulfuric acid), a porosity ratio equivalent to the porosity ratio of the porous membrane before being brought into contact with the electrolytic solution can be used.

The weight loss rate A (thermal weight loss rate) of the porous membrane when the porous membrane is heated at 800° C. for 15 minutes may be in the following range based on the porous membrane before being heated at 800° C. The weight loss rate A may be 1% or more, more than 1%, 3% or more, 5% or more, more than 5%, 8% or more, 10% or more, 12% or more, 14% or more, 15% or more, 15.5% or more, or 15.8% or more, from the viewpoint of easily suppressing permeation short-circuiting. The weight loss rate A may be 30% or less, 25% or less, 20% or less, 18% or less, 17% or less, 16% or less, or 15.8% or less, from the viewpoint of easily suppressing permeation short-circuiting. From these viewpoints, the weight loss rate A may be 1 to 30%, more than 1% and 30% or less, 5 to 25%, more than 5% and 25% or less, or 10 to 20%. The weight loss rate A indicates the content of the organic material removed when the porous membrane is heated at 800° C. for 15 minutes. As for the weight loss rate A, from the viewpoint of removing moisture, the porous membrane may be heated at 100° C. for 60 minutes before being heated at 800° C. for 15 minutes.

Before being accommodated in the lead acid storage battery or after being accommodated in the lead acid storage battery, the basis weight of the porous membrane may be in the following range. The basis weight of the porous membrane may be 10 g/m² or more, 15 g/m² or more, 20 g/m² or more, 25 g/m² or more, or 30 g/m² or more. The basis weight of the porous membrane may be 50 g/m² or less, 45 g/m² or less, 40 g/m² or less, 35 g/m² or less, 30 g/m² or less, or 25 g/m² or less. From these viewpoints, the basis weight of the porous membrane may be 10 to 50 g/m², 20 to 40 g/m², 25 to 50 g/m², or 10 to 30 g/m².

The lead acid storage battery of the present embodiment may have an electrolytic solution. The electrolytic solution can be accommodated in the battery container. The electrolytic solution may contain sulfuric acid and may contain sulfate ions. The electrolytic solution may contain metal ions such as aluminum ions.

The specific gravity (before chemical formation) of the electrolytic solution may be in the following range. The specific gravity of the electrolytic solution may be 1.30 or less, 1.25 or less, 1.24 or less, 1.23 or less, 1.22 or less, 1.21 or less, 1.20 or less, or 1.19 or less, from the viewpoint of easily suppressing permeation short-circuiting. The specific gravity of the electrolytic solution may be 1.10 or more, 1.12 or more, 1.14 or more, 1.15 or more, 1.16 or more, 1.18 or more, or 1.19 or more, from the viewpoint of easily suppressing permeation short-circuiting. From these viewpoints, the specific gravity of the electrolytic solution may be 1.10 to 1.30, 1.12 to 1.25, or 1.15 to 1.20.

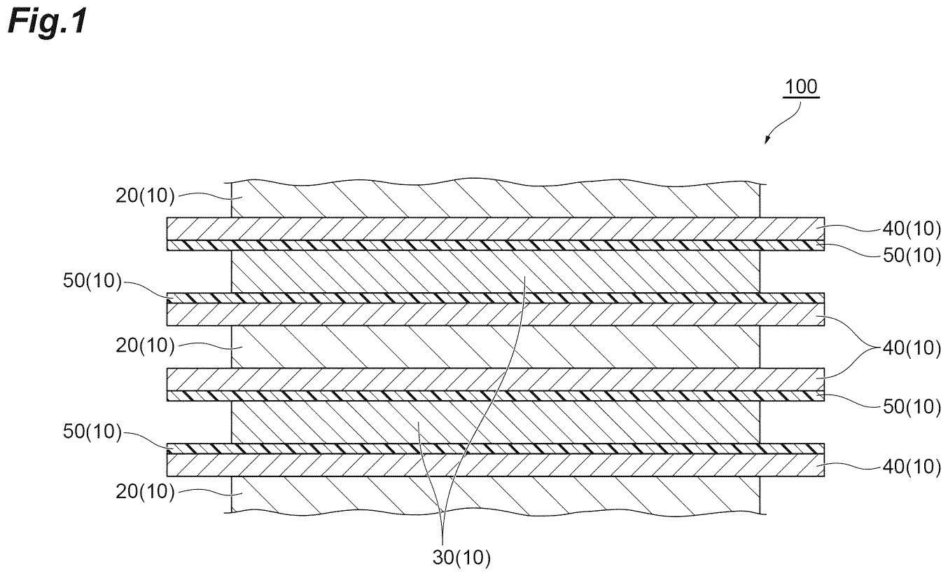

An example of the lead acid storage battery is illustrated with reference to FIG. 1. FIG. 1 is an end view of the lead acid storage battery as viewed in a vertical direction.

A lead acid storage battery 100 illustrated in FIG. 1 has an electrode group 10, an electrolytic solution (not illustrated), and a battery container (not illustrated) accommodating the electrode group 10 and the electrolytic solution. The electrode group 10 has a plurality of positive electrodes 20, a plurality of negative electrodes 30, a plurality of separators 40 each disposed between the positive electrode 20 and the negative electrode 30, and a plurality of porous membranes 50 each disposed between the negative electrode 30 and the separator 40. The positive electrode 20 and the negative electrode 30 are alternately disposed with the separator 40 and the porous membrane 50 interposed therebetween, and the separator 40 and the porous membrane 50 are disposed between the positive electrode 20 and the negative electrode 30.

The separator 40 is formed by folding back the sheet-shaped separator so as to cover the positive electrode 20. One surface of the separator 40 (the inner surface when the separator 40 is folded back) is brought into contact with the positive electrode 20, and the other surface of the separator 40 (the outer surface when the separator 40 is folded back) is brought into contact with the porous membrane 50. The separator 40 covers the entire active material region of the positive electrode 20.

The porous membrane 50 is formed by folding back the sheet-shaped porous membrane so as to cover the positive electrode 20 and the separator 40. One surface of the porous membrane 50 (the inner surface when the porous membrane 50 is folded back) is brought into contact with the separator 40, and the other surface of the porous membrane 50 (the outer surface when the porous membrane 50 is folded back) is brought into contact with the negative electrode 30. The porous membrane 50 covers the entire active material region of the negative electrode 30. The porous membrane 50 is disposed between the negative electrode 30 and the separator 40.

A method for producing a lead acid storage battery of the present embodiment is a method for producing a lead acid storage battery having a positive electrode, a negative electrode, a separator, and a porous membrane (a production method for obtaining the lead acid storage battery of the present embodiment), the method including a porous membrane disposing step of disposing a porous membrane having a void ratio of the porous membrane as obtained by X-ray CT measurement of 18.0% or more between the positive electrode and the negative electrode, in which in the lead acid storage battery, the separator and the porous membrane contain a glass fiber and are disposed between the positive electrode and the negative electrode, and the porous membrane is disposed in at least one of a position between the positive electrode and the separator and a position between the negative electrode and the separator. As for each configuration of the positive electrode, the negative electrode, the separator, and the porous membrane, each configuration (for example, the thicknesses of the separator and the porous membrane) described above for the lead acid storage battery can be adopted.

A weight loss rate B of the porous membrane when the porous membrane to be disposed in the porous membrane disposing step is immersed in sulfuric acid for 24 hours may be in the following range based on the porous membrane before being immersed in sulfuric acid. The weight loss rate B may be 1% or more, more than 1%, 2% or more, 3% or more, 5% or more, more than 5%, 6% or more, 7% or more, or 7.5% or more, from the viewpoint of easily suppressing permeation short-circuiting. The weight loss rate B may be 15% or less, 12% or less, 10% or less, 9% or less, 8% or less, 7.5% or less, 7% or less, 6% or less, 5% or less, less than 5%, 3% or less, or 2% or less, from the viewpoint of easily suppressing permeation short-circuiting. From these viewpoints, the weight loss rate B may be 1 to 15%, more than 1% and 15% or less, 1 to 10%, 1 to 5%, or 5 to 10%. The weight loss rate B indicates the content of the organic material dissolved when the porous membrane is immersed in sulfuric acid. In the measurement of the weight loss rate B, the porous membrane may be immersed in sulfuric acid having a specific gravity of 1.28 (25° C.) for 24 hours.

In the porous membrane disposing step, the porous membrane may be disposed in a state where the separator is disposed between the positive electrode and the negative electrode, the porous membrane may be disposed between the positive electrode and the negative electrode in a state where the separator is not disposed between the positive electrode and the negative electrode, and the separator and the porous membrane may be collectively disposed between the positive electrode and the negative electrode.

In the porous membrane disposing step, in a case where the porous membrane is disposed in a state where the separator is disposed between the positive electrode and the negative electrode, the method for producing a lead acid storage battery of the present embodiment may include a separator disposing step of disposing the separator between the positive electrode and the negative electrode before the porous membrane disposing step. In the porous membrane disposing step, in a case where the porous membrane is disposed between the positive electrode and the negative electrode in a state where the separator is not disposed between the positive electrode and the negative electrode, the method for producing a lead acid storage battery of the present embodiment may include a separator disposing step of disposing the separator between the positive electrode and the negative electrode after the porous membrane disposing step. As a weight loss rate corresponding to a weight loss rate B described above, the weight loss rate of the separator when the separator to be disposed in the separator disposing step is immersed in sulfuric acid for 24 hours may be 5% or less, less than 5%, or 1% or less, based on the separator before being immersed in sulfuric acid.

The method for producing a lead acid storage battery of the present embodiment may include an electrode group accommodating step of accommodating an electrode group obtained by a method for producing an electrode group of the present embodiment in a battery container. The method for producing a lead acid storage battery of the present embodiment may include an electrolytic solution supplying step of supplying an electrolytic solution to a battery container before or after the electrode group accommodating step.

In the method for producing a lead acid storage battery and the method for producing an electrode group of the present embodiment, as steps other than the above-described respective steps, general steps for obtaining a lead acid storage battery and an electrode group can be adopted.

### EXAMPLES

Hereinafter, the present disclosure will be more specifically described by means of Examples and Comparative Examples; however, the present disclosure is not limited to the following Examples.

### <Production of Electrode>

As the raw material for the positive electrode active material, a lead powder and red lead (Pb₃O₄) were used (lead powder:red lead=96:4 (mass ratio)). The raw material for the positive electrode active material, 0.07% by mass of short fibers for reinforcement (acrylic fibers) based on the total mass of the raw material for the positive electrode active material, and water were mixed and kneaded. Subsequently, kneading was performed while adding dilute sulfuric acid (specific gravity: 1.280) little by little to prepare a paste-like positive electrode active material.

As the raw material for the negative electrode active material, a lead powder was used. A mixture containing 0.2% by mass (in terms of a solid content) of a lignin-based resin (lignin sulfonate), 0.1% by mass of short fibers for reinforcement (acrylic fibers), 1.0% by mass of barium sulfate, and 0.2% by mass of a carbon material (furnace black) was added to the lead powder, and then dry-mixing was performed (the blending amount is a blending amount based on the total mass of the raw material for the negative electrode active material). Next, after adding water, kneading was performed. Subsequently, kneading was performed while adding dilute sulfuric acid (specific gravity: 1.280) little by little to prepare a paste-like negative electrode active material.

An electrode plate (positive electrode current collector) was filled with the paste-like positive electrode active material and an electrode plate (negative electrode current collector) was filled with the paste-like negative electrode active material so that a ratio (N/P) of the total mass (N) of the negative electrode active material and the total mass (P) of the positive electrode active material in a control valve type lead acid storage battery in a fully charged state was 0.7. As the electrode plate, a casted grid body formed from a lead alloy was used.

A chemically unformed positive electrode (length: 115 mm, width: 58 mm, thickness: 4.1 mm (the dimension of the active material region: length 115 mm, width 58 mm)) was produced using the electrode plate filled with the paste-like positive electrode active material through an aging step under the following Aging conditions 1 to 3 and a drying step under the following Drying condition.
Aging condition 1 “temperature: 80° C., humidity: 98%, time: 10 hours”
Aging condition 2 “temperature: 65° C., humidity: 75%, time: 13 hours”
Aging condition 3 “temperature: 40° C., humidity: 65%, time: 40 hours”
Drying condition “temperature: 60° C., time: 24 hours”

A chemically unformed negative electrode (length: 116 mm, width: 58 mm, thickness: 2.5 mm (the dimension of the active material region: length 116 mm, width 58 mm)) was produced using the electrode plate filled with the paste-like negative electrode active material through an aging step under an aging condition “temperature: 40° C., humidity: 98%, time: 40 hours” and a drying step under a drying condition “temperature: 60° C., time: 24 hours”.

### <Preparation of Porous Membrane>

As a porous membrane (a porous membrane before being accommodated in the lead acid storage battery), the following nonwoven fabrics (length 250 mm, width 65 mm) were prepared.
Porous membrane A: Porous membrane having a basis weight of 21 g/m², a thickness of 0.10 mm, and a porosity ratio of 80.5% by volume, and containing a glass fiber and a (meth)acrylic binder
Porous membrane B: Porous membrane having a basis weight of 33.5 g/m², a thickness of 0.30 mm, and a porosity ratio of 79.6% by volume, and containing a glass fiber and a (meth)acrylic binder
Porous membrane C: Porous membrane having a basis weight of 20 g/m², a thickness of 0.07 mm, and a porosity ratio of 71.2% by volume, and containing polypropylene and pulp
Porous membrane D: Porous membrane having a basis weight of 28 g/m², a thickness of 0.11 mm, and a porosity ratio of 80.4% by volume, and containing polyacrylonitrile and cellulose
Porous membrane E: Porous membrane having a basis weight of 21 g/m², a thickness of 0.15 mm, and a porosity ratio of 95.1% by volume, and containing a glass fiber and a binder

### <Evaluation of Porous Membrane>

### (Void Ratio)

The void ratio (the void ratio as viewed in a direction perpendicular to the main surface) of each of the above-described porous membranes A to E was measured according to the following procedures by using an X-ray CT apparatus (manufactured by SHIMADZU CORPORATION, trade name: SMX-160CTS).

First, a 25 mm×15 mm test piece was cut out from the vicinity of the center of the above-described porous membrane, and then this test piece was pasted to the side surface of a tip end portion of a sample stage (an acrylic resin rod with a diameter of about 5 mm) with double-sided tape. At this time, the test piece was disposed such that a 15 mm×15 mm region in the test piece protruded upwardly from the tip end of the sample stage while the sample stage was pasted to the center of the main surface of the test piece.

The test piece attached to the sample stage was disposed inside the X-ray CT apparatus, and then the test piece was irradiated with X rays (X-ray source: tungsten filament, using aluminum window) under the conditions of an X-ray tube voltage of 55 kV and brightness of 100 (max). Then, settings were performed as follows: “SID (Source Image Distance): 210 mm, SOD (Source Object Distance): 35 mm, detector inch size: 4 inches”, and adjustment was performed such that the above-described 15 mm×15 mm region was set as an observation target in a stage where the sample stage was not included in an observation region. Various calibrations of the apparatus (items such as horizontality, verticality, air, offset, and a mesh) were executed according to the manual of the X-ray CT apparatus. Furthermore, detailed central axis calibration was executed using a reference sample. The measurement was started under the conditions of “measurement mode: full scan, number of views: 1200, number of integrations: 6 times×2 rotations, scaling factor: 100, image size: 512×512 pixels”. At this time, a measurement region adjusted to a cylindrical shape having a diameter of 10.178 mm and a height of 8.588 mm was obtained.

The measurement results were 3D constructed using 3D construction software (manufactured by Volume Graphics, trade name: VG Studio MAX). The 3D image was rotated so that the main surface of the 3D image faced forward and the 3D image was converted into image data. Only the areas corresponding to the test piece (areas constituting the porous membrane) in the image data were extracted using calculation software (manufactured by Media Cybernetics, trade name: ImagePro), and then binarization of the areas corresponding to the porous membrane and areas not corresponding to the porous membrane (void parts) was performed. An area ratio of the black portions after binarization (areas not corresponding to the porous membrane) was obtained as a void ratio by using this calculation software. The results are shown in Table 1.

### (Thermal Weight Loss Rate)

The thermal weight loss rate of each of the above-described porous membranes A, B, and E was measured according to the following procedures. First, about 10 mg of a test piece was cut out from the vicinity of the center of the above-described porous membrane, and this test piece was placed in a container (aluminum pan). The container accommodating the test piece was placed in a thermogravimetric-differential thermal simultaneous measurement apparatus (manufactured by Hitachi High-Tech Science Corporation, trade name: STA7200). The test piece was heated under the conditions of “measurement atmosphere: air, flow rate: 100 mL/min, heating condition: raising temperature from 25° C. (room temperature) to 100° C. at 10° C./min→heating at 100° C. for 60 minutes (removing moisture)→raising temperature from 100° C. to 800° C. at 5° C./min→heating at 800° C. for 15 minutes”. A difference between a weight W11 at the end of heating at 100° C. for 60 minutes and a weight W12 at the end of heating at 800° C. for 15 minutes was calculated as a weight loss amount (W11−W12). A ratio of the weight loss amount (W11−W12) with respect to the weight W11 ([(W11−W12)/W11]×100) was obtained as a thermal weight loss rate (unit: %). The results are shown in Table 1.

### (Weight Loss Rate During Sulfuric Acid Immersion)

The weight loss rate when each of the above-described porous membranes A, B, D, and E was immersed in sulfuric acid was measured according to the following procedures. First, about 0.5 g of a test piece was cut out from the vicinity of the center of the above-described porous membrane, and a weight W21 of the test piece was measured. The test piece was dried at 50° C. for 1 hour while vacuuming with a vacuum dryer. The test piece was immersed in sulfuric acid (25° C.) having a specific gravity of 1.28 for 24 hours, and then the test piece was taken out from the sulfuric acid. The test piece was rinsed twice in ultrapure water, and then the test piece was immersed in a large amount of ultrapure water for 1 hour. The test piece was taken out from the ultrapure water, and then the test piece was dried at 50° C. After visually checking that the test piece was dried, the test piece was further dried for 1 hour while vacuuming. A weight W22 of the test piece was measured, and a difference between the weight W21 and the weight W22 was calculated as a weight loss amount (W21−W22). A ratio of the weight loss amount (W21−W22) with respect to the weight W21 ([(W21−W22)/W21]×100) was obtained as a weight loss rate (unit: %) during sulfuric acid immersion. The results are shown in Table 1.

### <Production of Separator>

As a separator with a length of 250 mm and a width of 65 mm (manufactured by Nippon Sheet Glass Co., Ltd., trade name: BMS-5), a separator A (thickness: 0.40 mm) and a separator B (thickness: 0.60 mm) were prepared. When the void ratio of the separator was measured by the same procedures as in the porous membrane described above, the void ratio of the separator A and the separator B was 1% or less. When the thermal weight loss rate of the separator was measured by the same procedures as in the porous membrane described above, the thermal weight loss rate of the separator A and the separator B was 1% or less. When the weight loss rate of the separator during sulfuric acid immersion was measured by the same procedures as in the porous membrane described above, the weight loss rate of the separator A and the separator B was 1% or less.

### <Production of Lead Acid Storage Battery>

### Examples 1 and 2 and Comparative Examples 1 to 3

The above-described separator A (thickness: 0.4 mm) was folded back in the longitudinal direction, and both main surfaces (the active material regions of the positive electrode) of the chemically unformed positive electrode were covered with the separator A, thereby obtaining a positive electrode member A. Furthermore, the above-described porous membrane was folded back in the longitudinal direction, and both main surfaces of the positive electrode member A were covered with the porous membrane, thereby obtaining a positive electrode member B. At this time, the longitudinal directions of the positive electrode, the separator A, and the porous membrane were same as each other, and the separator A and the porous membrane were disposed such that the folded-back portions of the separator A and the porous membrane were located on one end side in the longitudinal direction of the positive electrode (the lower end side in the vertical direction of the positive electrode in a state where the positive electrode was accommodated in the lead acid storage battery). Subsequently, three sheets of the positive electrode members B and four sheets of the chemically unformed negative electrodes were alternately laminated to produce an electrode group. The electrode group and a spacer were inserted into a battery container, a positive electrode terminal and a negative electrode terminal were then welded to the electrode group, and further, the battery container was sealed. At this time, a distance between the positive electrode and the negative electrode was adjusted to 0.41 mm by adjusting the thickness of the spacer. Then, am electrolytic solution containing dilute sulfuric acid having a specific gravity of 1.19 as a main component was poured into the battery container through an exhaust plug port, and then a cap for battery container chemical formation was mounted, thereby producing a total of two lead acid storage batteries (battery capacity: 15 Ah) for each of Examples and Comparative Examples.

### Comparative Example 4

A total of two lead acid storage batteries (battery capacity: 15 Ah) were produced by performing the same operation as described above, except that the separator B (thickness: 0.6 mm) was used instead of the separator A and three sheets of the positive electrode members A and four sheets of the chemically unformed negative electrodes were alternately laminated without using the porous membrane to produce an electrode group.

### <Permeation Short-Circuiting Evaluation>

For permeation short-circuiting evaluation, the two lead acid storage batteries described above were left to stand still in a water tank at 40° C. for 3 hours, and then charging and discharging (battery container chemical formation) were performed according to the procedures below. A case where neither of the two lead acid storage batteries underwent permeation short-circuiting was evaluated as “A”, and a case where one or two of the lead acid storage batteries underwent permeation short-circuiting was evaluated as “B”. A case where the inter-terminal voltage was dropped to 1.0 V was determined to be permeation short-circuiting. The results are shown in Table 1.

### {Charging and Discharging Conditions}

First charge: current 3.0 A, 15.0 hours
First discharge: current 3.0 A, 1.5 hours
Second charge: current 3.0 A, 19.0 hours
Second discharge: current 3.0 A, 3.0 hours
Third charge: current 3.0 A, 16.0 hours
Third discharge: current 3.0 A, 3.5 hours
Fourth charge: current 1.5 A, 9.0 hours

TABLE 1

| | | Porous membrane | | | | |
|---|---|---|---|---|---|---|
| | | | | | Weight loss | |
| | | | | Thermal | rate during | |
| | | | Void | weight | sulfuric acid | |
| | | | ratio | loss rate | immersion | Permeation |
| | | Type | [%] | [%] | [%] | short-circuiting |
| Example | 1 | A | 25.7 | 15.9 | 7.94 | A |
| | 2 | B | 26.2 | 15.6 | 1.87 | A |
| Comparative | 1 | C | 13.3 | — | — | B |
| Example | 2 | D | 15.1 | — | 5.71 | B |
| | 3 | E | 17.7 | 13.8 | 15.9 | B |
| | 4 | None | — | — | — | B |

### REFERENCE SIGNS LIST

10: electrode group, 20: positive electrode, 30: negative electrode, 40: separator, 50: porous membrane, 100: lead acid storage battery.

1. A lead acid storage battery comprising a positive electrode, a negative electrode, a separator, and a porous membrane,
wherein the separator and the porous membrane contain a glass fiber and are disposed between the positive electrode and the negative electrode,
the porous membrane is disposed in at least one of a position between the positive electrode and the separator and a position between the negative electrode and the separator, and
a void ratio of the porous membrane as obtained by X-ray CT measurement is 18.0% or more.

2. The lead acid storage battery according to claim 1, wherein the porous membrane includes a porous membrane disposed between the negative electrode and the separator.

3. The lead acid storage battery according to claim 1, wherein the porous membrane is a nonwoven fabric.

4. The lead acid storage battery according to claim 1, wherein a thickness of the porous membrane is smaller than a thickness of the separator.

5. The lead acid storage battery according to claim 1, wherein a thickness of the porous membrane is 0.01 to 0.50 mm.

6. A method for producing the lead acid storage battery according to claim 1, the method comprising:
disposing the porous membrane between the positive electrode and the negative electrode.

7. The lead acid storage battery according to claim 1, wherein the void ratio of the porous membrane is 18.0 to 50.0%.

8. The lead acid storage battery according to claim 1, wherein the void ratio of the porous membrane is 18.0 to 40.0%.

9. The lead acid storage battery according to claim 1, wherein the void ratio of the porous membrane is 18.0 to 30.0%.

10. The lead acid storage battery according to claim 1, wherein the void ratio of the porous membrane is 25.0 to 50.0%.

11. The lead acid storage battery according to claim 1, wherein a thickness of the porous membrane is 0.22 to 0.50 mm.

12. The lead acid storage battery according to claim 1, wherein a thickness of the porous membrane is 0.01 to 0.20 mm.

13. The lead acid storage battery according to claim 1, wherein a thickness of the separator is 0.1 to 0.65 mm.

14. The lead acid storage battery according to claim 1, wherein a thickness of the separator is 0.1 to 0.5 mm.

15. The lead acid storage battery according to claim 1, wherein a void ratio of the separator as obtained by X-ray CT measurement is less than 18.0%.

16. The lead acid storage battery according to claim 1, wherein a ratio of a thickness of the porous membrane with respect to a thickness of the separator is 0.3 or more.

17. The lead acid storage battery according to claim 1, wherein a ratio of a thickness of the porous membrane with respect to a thickness of the separator is 0.3 or less.

18. The lead acid storage battery according to claim 1, wherein the porous membrane is not brought into contact with the positive electrode.
